(19) United States
(12) Patent Application Publication
(10) Pub. No.: US 2025/0108776 A1
(43) Pub. Date: Apr. 3, 2025

(54) WIPING DEVICE

(71) Applicant: MITSUBA Corporation, Gunma (JP)

(72) Inventors: TOSHIYUKI AMAGASA, Gunma (JP); DAICHI MUNEKATA, Gunma (JP); MASAKAZU NAKAJIMA, Gunma (JP)

(73) Assignee: MITSUBA Corporation, Gunma (JP)

(21) Appl. No.: 18/801,834

(22) Filed: Aug. 13, 2024

(30) Foreign Application Priority Data
Oct. 3, 2023 (JP) 2023-171810

(51) Int. Cl. B60S 1/08

(52) U.S. Cl. CPC B60S 1/0818

(57) ABSTRACT

A wiping device wipes off rainwater on a wiped surface by reciprocating a wiper blade using a predetermined power source. The wiping device includes: a drive circuit, driving the power source, and a control part, controlling the drive circuit. The control part switches a wiping range at an upper reversal position of the wiper blade.

### CROSS-REFERENCE TO RELATED APPLICATIONS

This application claims the priority benefit of Japan Application No. 2023-171810, filed on Oct. 3, 2023. The entirety of the above-mentioned patent application is hereby incorporated by reference herein and made a part of this specification.

### BACKGROUND

### Technical Field

The disclosure relates to a wiping device.

### Related Art

Japanese Patent Laid-open No. 2005-082104 discloses a wiper control device for a vehicle that selectively and intensively wipes a dirty portion or the like. This wiper control device for a vehicle includes: a DC motor device, for reciprocally sliding a wiper blade member along a surface of a car window glass member; a motor rotation control means, controlling rotation of the DC motor device; a power supply line, arranged in a bridge circuit shape for supplying power to the DC motor device; a current detection means, detecting a current flowing through the power supply line during sliding of the wiper blade member; and a current displacement detection means, detecting that a displacement amount per unit time of a detected value by the current detection means exceeds a predetermined threshold. The motor rotation control means switches a rotation direction of the DC motor device so that the wiper blade member repeatedly slides on a detection portion of the current displacement detection means.

According to this wiper control device for a vehicle, since the rotation direction of the DC motor device is switched between forward and reverse so that the wiper blade member repeatedly slides on the detection portion of the current displacement detection means, it is possible to selectively and intensively wipe only a portion where dirt or the like adheres to the car window glass member.

In the related art, when the wiper blade member (wiper blade) repeatedly slides on the detection portion of the current displacement detection means, a wiping range of the wiper blade is different from a normal wiping range. That is, the wiping range when wiping is selectively and intensively performed on a dirty portion or the like is smaller than the normal wiping range. In this way, during switching of the wiping range, abnormality may occur in the behavior of the wiper blade.

### SUMMARY

A wiping device that wipes off rainwater on a wiped surface by reciprocating a wiper blade using a predetermined power source includes: a drive circuit, driving the power source; and a control part, controlling the drive circuit. The control part switches a wiping range at a timing at which a target speed becomes zero both before and after the switching.

### BRIEF DESCRIPTION OF THE DRAWINGS

FIG. 1 is a block diagram showing a functional configuration of a wiping device according to a first embodiment of the disclosure.

FIG. 2 is a first flowchart showing an operation of the wiping device according to the first embodiment of the disclosure.

FIG. 3 is a waveform diagram showing an operation of the wiping device according to the first embodiment of the disclosure.

FIG. 4 is a reference diagram regarding an operation of the wiping device according to the first embodiment of the disclosure.

FIG. 5 is a block diagram showing a functional configuration of a wiping device according to a second embodiment of the disclosure.

### DESCRIPTION OF THE EMBODIMENTS

The disclosure provides a wiping device in which abnormal behavior of a wiper blade during switching of a wiping range can be suppressed.

In the disclosure, as a first solution pertaining to a wiping device, a wiping device that wipes off rainwater on a wiped surface by reciprocating a wiper blade using a predetermined power source includes: a drive circuit, driving the power source; and a control part, controlling the drive circuit. The control part switches a wiping range at a timing at which a target speed becomes zero both before and after the switching.

In the disclosure, as a second solution pertaining to the wiping device, in the first solution, the wiping range includes: a normal wiping range in a normal mode; and a narrow wiping range in a heavy rain mode, smaller than the normal wiping range.

In the disclosure, as a third solution pertaining to the wiping device, in the second solution, the control part performs the switching from the normal mode to the heavy rain mode at an upper reversal position of the wiper blade.

In the disclosure, as a fourth solution pertaining to a wiping device, in any one of the first to third solutions, the power source reciprocates a pair of the wiper blades at the same time.

In the disclosure, as a fifth solution pertaining to a wiping device, in any one of the first to third solutions, the power source is provided in a pair. The power source provided in a pair reciprocates the wiper blade corresponding thereto.

According to the disclosure, it is possible to provide a wiping device in which abnormal behavior of a wiper blade member during switching of a wiping range can be suppressed.

### First Embodiment

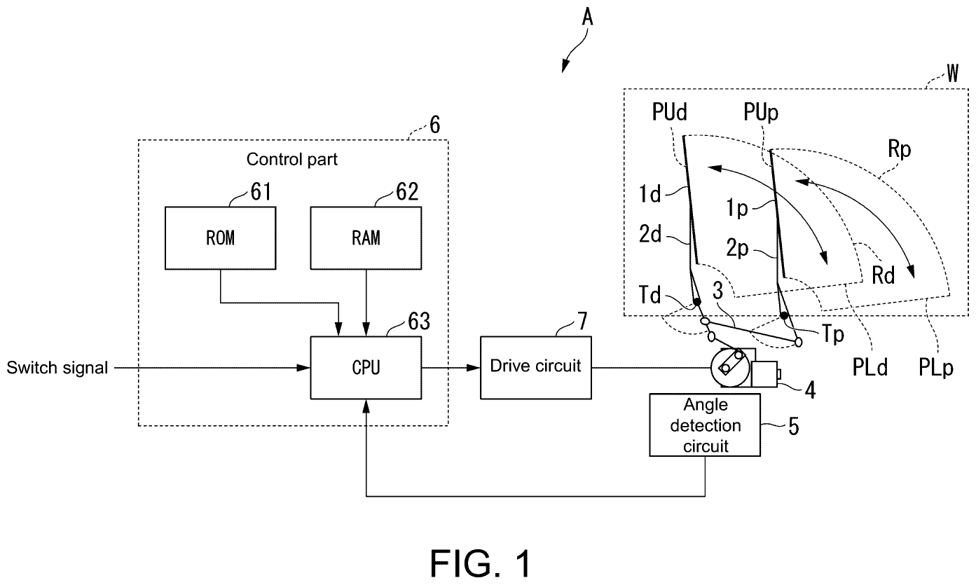

First of all, a first embodiment of the disclosure will be described with reference to FIG. 1 to FIG. 4. A wiping device A according to the first embodiment is a device that is installed in various moving vehicles such as a gasoline car, a hybrid car, or an electric car, and wipes off rainwater adhering to a surface (wiped surface W) of a member to be wiped, such as a windshield or a rear glass.

As shown in FIG. 1, the wiping device A according to the first embodiment includes a pair of wiper blades 1d and 1p, a pair of wiper arms 2d and 2p, a link mechanism 3, a motor 4 (power source), an angle detection circuit 5, a control part 6, and a drive circuit 7. As illustrated, the control part 6 includes a read only memory (ROM) 61, a random access memory (RAM) 62, and a central processing unit (CPU) 63.

The wiping device A employs a single motor drive system in which the pair of wiper arms 2d and 2p are mechanically connected by the link mechanism 3, thereby driving the pair of wiper blades 1d and 1p by the motor 4 (power source) that is singly provided. That is, in the wiping device A, one power source is provided, and the pair of wiper blades 1d and 1p are reciprocated at the same time by the one power source. The wiping device A employs a parallel wiping type in which the pair of wiper blades 1d and 1p move in the same direction, as shown in FIG. 1.

Here, regarding the reference numerals in FIG. 1, “d” indicates a member or portion related to a driver's seat side of a vehicle. “p” indicates a member or portion related to a passenger seat side of the vehicle. In FIG. 1, the symbol Rd indicates a wiping range (driver's seat normal wiping range) of the wiper blade 1d on the driver's seat side when an operation mode of the wiping device A is set to a normal mode. The symbol Rp indicates a wiping range (passenger seat normal wiping range) of the wiper blade 1p on the passenger seat side when the operation mode is set to the normal mode.

The driver's seat normal wiping range Rd is a range extending from a lower reversal position PLd to an upper reversal position PUd as a movement trajectory of the wiper blade 1d on the driver's seat side. The lower reversal position PLd is a position where the wiper blade 1d on the driver's seat side switches from a lowering movement to a rising movement on the wiped surface W. The upper reversal position PUd is a position where the wiper blade 1d on the driver's seat side switches from the rising movement to the lowering movement on the wiped surface W.

The passenger seat normal wiping range Rp is a range extending from a lower reversal position PLp to an upper reversal position PUp as a movement trajectory of the wiper blade 1p on the passenger seat side. The lower reversal position PLp is a position where the wiper blade 1p on the passenger seat side switches from the lowering movement to the rising movement on the wiped surface W. The upper reversal position PUp is a position where the wiper blade 1p on the passenger seat side switches from the rising movement to the lowering movement on the wiped surface W.

Although details will be described later, the wiping device A includes, as an operation mode, a heavy rain mode which is different from the normal mode. The heavy rain mode is an operation mode in which wiping is performed in a wiping range smaller than the driver's seat normal wiping range Rd and the passenger seat normal wiping range Rp in the normal mode. That is, the heavy rain mode is a mode in which wiping is performed in a range smaller than the driver's seat normal wiping range Rd and the passenger seat normal wiping range Rp in the normal mode, and is an operation mode in which a reciprocation speed is faster than in the normal mode.

For example, in the wiping range in the heavy rain mode, while upper reversal positions are the same as the upper reversal positions PUd and PUp in the driver's seat normal wiping range Rd and the passenger seat normal wiping range Rp, lower reversal positions are set to positions (lower reversal positions QLd and QLp) higher than the lower reversal positions PLd and PLp in the driver's seat normal wiping range Rd and the passenger seat normal wiping range Rp. Such a wiping range in the heavy rain mode is, for example, a front visual field “zone A” set by the law.

Here, “zone A” indicates a range corresponding to “area A” in the wiping area regulations of the laws of Japan and the European Economic Community (EEC), or “area C” in the wiping area regulations of the Federal Motor Vehicle Safety Standards (FMVSS).

As illustrated, the pair of wiper blades 1d and 1p are rod-shaped members arranged on the wiped surface W. The pair of wiper blades 1d and 1p are in contact with the wiped surface W, and perform a reciprocating motion (swinging motion) on the wiped surface W, thereby wiping off rainwater present on the wiped surface W. The pair of wiper blades 1d and 1p are mechanically connected to the motor 4 via the pair of wiper arms 2d and 2p.

That is, the wiper blade 1d on the driver's seat side is connected to the motor 4 via the wiper arm 2d provided on the driver's seat side. The wiper blade 1p on the passenger seat side is connected to the motor 4 via the wiper arm 2p and the link mechanism 3 provided on the passenger seat side.

As illustrated, the pair of wiper arms 2d and 2p are rod-shaped members having one end connected to an intermediate position in the wiper blades 1d and 1p, and the other end connected to a pair of wiper shafts Td and Tp. That is, the wiper arm 2d on the driver's seat side has one end connected to the intermediate position in the wiper blade 1d on the driver's seat side, and has the other end connected to the wiper shaft Td on the driver's seat side.

On the other hand, the wiper arm 2p on the passenger seat side has one end connected to the intermediate position in the wiper blade 1p on the passenger seat side, and has the other end connected to the wiper shaft Tp on the passenger seat side. Such a pair of wiper arms 2d and 2p are members included in the components of the pair of wiper blades 1d and 1p.

Such a pair of wiper arms 2d and 2p function as power transmission components that mechanically transmit a rotational force of the motor 4 to the pair of wiper blades 1d and 1p. The pair of wiper arms 2d and 2p function as energization members that press the pair of wiper blades 1d and 1p against the wiped surface W with a predetermined pressing force.

The link mechanism 3 is a mechanical component mechanically connected to the other ends of the pair of wiper arms 2d and 2p, and also connected to an output shaft of the motor 4. The link mechanism 3 includes a support shaft fixed to the vehicle, and is rotatable around the support shaft. The output shaft of the motor 4 is connected to the link mechanism 3. By manipulating a rotational angle of the link mechanism 3, the pair of wiper blades 1d and 1p are swung on the wiped surface W. The motor 4 is a predetermined power source in the first embodiment.

The angle detection circuit 5 outputs an angle signal proportional to a rotation angle of the motor 4 to the CPU 63. This angle signal is a signal indicating an operation angle of the pair of wiper blades 1d and 1p mechanically connected by the link mechanism 3. In detail, such an angle signal includes a relative position signal indicating relative positions of the pair of wiper blades 1d and 1p, and an absolute position signal indicating absolute positions of the pair of wiper blades 1d and 1p.

The relative position signal is a pulse signal (motor pulse) generated as the motor 4 rotates, and is a pulse signal (pulse train) with a number of pulses proportional to the rotation angle of the motor 4. In contrast, the absolute position signal is a single pulse signal that is emitted when the pair of wiper blades 1d and 1p reach a control reference position. The control reference position is, for example, the lower reversal positions PLd and PLp.

The control part 6 includes the normal mode and the heavy rain mode as control modes. By performing control processing according to the operation mode, the control part 6 generates a drive command according to the operation mode. By outputting the drive command to the drive circuit 7, the control part 6 controls movement of the pair of wiper blades 1d and 1p.

The normal mode is a control mode for the pair of wiper blades 1d and 1p with respect to normal rainfall. When an instruction indicating the normal mode is given by a switch signal input from a host control device, the control part 6 generates the drive command in accordance with the normal mode and outputs it to the drive circuit 7. The switch signal is a host control command that instructs the wiping device A to turn on/off a wiper switch provided in the vehicle, specify the heavy rain mode, turn on/off a mist switch, perform intermittent operation (Lo, Hi, INT), or the like.

On the other hand, the heavy rain mode is a control mode for the pair of wiper blades 1d and 1p with respect to sudden heavy rain. When an instruction indicating the heavy rain mode is given by the switch signal, the control part 6 generates the drive command in accordance with the heavy rain mode and outputs it to the drive circuit 7.

In controlling the pair of wiper blades 1d and 1p, the control part 6 refers to the switch signal input from the host control device and the angle signal input from the angle detection circuit 5. That is, the control part 6 performs feedback control on the pair of wiper blades 1d and 1p based on the switch signal and the angle signal.

In such a control part 6, the ROM 61 is a nonvolatile memory. The ROM 61 stores a control program executed by the CPU 63 in order to perform feedback control on the pair of wiper blades 1d and 1p. The ROM 61 stores a normal mode operation map and a heavy rain mode operation map necessary for the CPU 63 to execute the control program.

The normal mode operation map is a control map used when the CPU 63 executes control processing (normal control processing) in the control program that relates to the normal mode. That is, the normal mode operation map is a control data group indicating target speeds of the pair of wiper blades 1d and 1p in the normal mode in a time series.

On the other hand, the heavy rain mode operation map is a control map used when the CPU 63 executes control processing (heavy rain control processing) in the control program that relates to the heavy rain mode. That is, the heavy rain mode operation map is a control data group indicating target speeds of the pair of wiper blades 1d and 1p in the heavy rain mode in a time series.

The RAM 62 is a volatile memory. The RAM 62 temporarily stores various data generated when the CPU 63 executes the control program. The RAM 62 temporarily stores, for example, a flag (control flag F) indicating whether the control mode being executed is the normal mode or the heavy rain mode, and a counter value (wiping count value N) indicating a wiping count in the control mode being executed.

The CPU 63 generates a drive command by executing the control program stored in advance in the ROM 61, and outputs this drive command to the drive circuit 7. When executing the control program, the CPU 63 refers to the switch signal input from the host control device, the angle signal input from the angle detection circuit 5, and the normal mode operation map and the heavy rain mode operation map stored in advance in the ROM 61.

That is, by referring to the switch signal, the angle signal, the normal mode operation map and the heavy rain mode operation map based on the control program, the CPU 63 generates the drive command. This drive command is a control command that instructs the drive circuit 7 to drive the pair of wiper blades 1d and 1p according to the control mode (normal mode or heavy rain mode). The drive command is also a control command to make a movement speed of the pair of wiper blades 1d and 1p obtained from the angle signal equal to the target speed indicated by the normal mode operation map or the heavy rain mode operation map.

The drive circuit 7 generates a drive signal based on the drive command input from the CPU 63 (control part 6), and outputs the drive signal to the motor 4. The drive circuit 7 is, for example, an inverter circuit including a plurality of switching transistors. In this case, the drive command is a pulse width modulation (PWM) signal whose duty ratio is variably set according to a deviation between the target speed and the movement speed of the pair of wiper blades 1d and 1p.

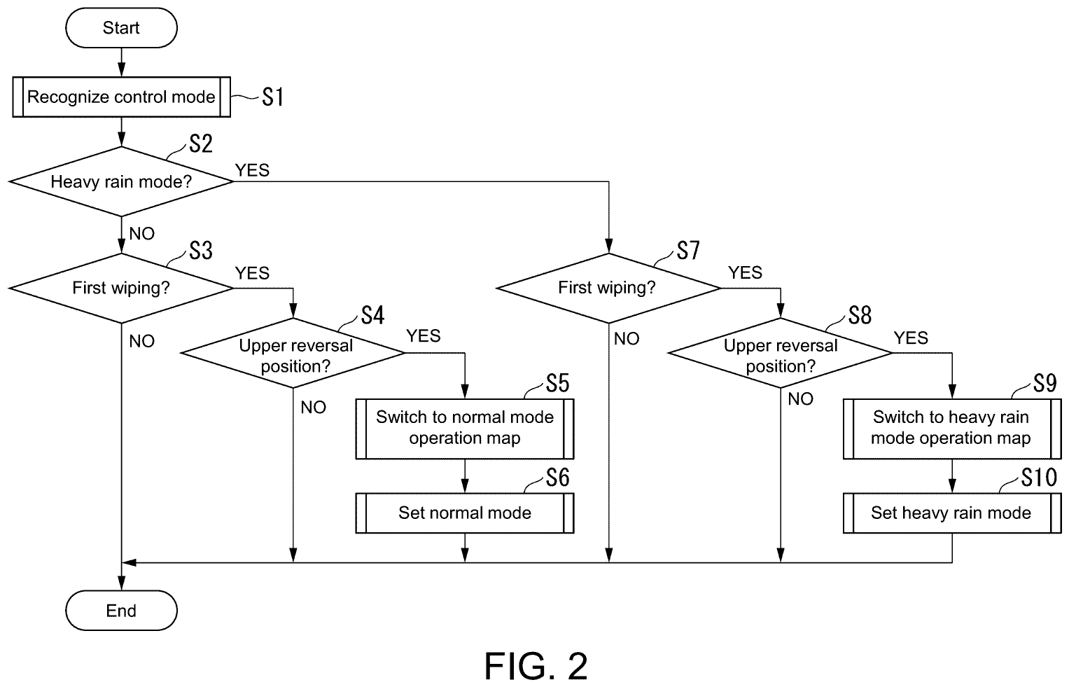

Next, a characteristic operation of the wiping device A according to the first embodiment is described in accordance with a flowchart shown in FIG. 2. This flowchart shows a procedure for control processing in the CPU 63 (control part 6).

First of all, by referring to a switch signal input from a host control device, the CPU 63 recognizes an operation mode indicated by an instruction from the host control device (step S1). Then, the CPU 63 executes each processing in the following steps S2 to S10 based on the recognition in step S1.

That is, the CPU 63 determines whether the heavy rain mode has been indicated by the instruction from the host control device (step S2). If the determination in step S2 is “NO”, that is, if the normal mode is indicated by the instruction from the host control device, the CPU 63 refers to the wiping count value N, thereby determining whether the wiping in the normal mode is the first wiping (first wiping) (step S3).

If the determination in step S3 is “NO”, that is, if the wiping in the normal mode is not first wiping, the CPU 63 ends the processing. On the other hand, if the determination in step S3 is “YES”, that is, if the wiping in the normal mode is first wiping, the CPU 63 refers to an angle signal, thereby determining whether operation angles of the pair of wiper blades 1d and 1p have reached the upper reversal positions PUd and PUp (step S4).

If the determination in step S4 is “NO”, that is, if the operation angles of the pair of wiper blades 1d and 1p have not reached the upper reversal positions PUd and PUp, the CPU 63 ends the processing. On the other hand, if the determination in step S4 is “YES”, that is, if the operation angles of the pair of wiper blades 1d and 1p have reached the upper reversal positions PUd and PUp, the CPU 63 switches a control map that has been used for generating a drive command to the normal mode operation map (step S5).

For example, in a state in which the wiping device A is operating in the heavy rain mode, the control map is switched from the heavy rain mode operation map to the normal mode operation map in step S5. By switching the control map from the heavy rain mode operation map to the normal mode operation map, the CPU 63 sets the control mode to the normal mode (step S6).

That is, when the processing in step S6 is completed, the CPU 63 performs processing for generating the drive command based on the normal mode operation map. Accordingly, the pair of wiper blades 1d and 1p wipe off rainwater in a normal manner by reciprocating in the driver's seat normal wiping range Rd and the passenger seat normal wiping range Rp extending from the lower reversal positions PLd and PLp to the upper reversal positions PUd and PUp.

If the determination in step S2 is “YES”, that is, if the heavy rain mode is indicated by the instruction from the host control device, the CPU 63 refers to the wiping count value N, thereby determining whether the wiping in the heavy rain mode is the first wiping (first wiping) (step S7).

If the determination in step S7 is “NO”, that is, if the wiping in the heavy rain mode is not first wiping, the CPU 63 ends the processing. On the other hand, if the determination in step S7 is “YES”, that is, if the wiping in the heavy rain mode is first wiping, the CPU 63 refers to an angle signal, thereby determining whether the operation angles of the pair of wiper blades 1d and 1p have reached the upper reversal positions PUd and PUp (step S8).

If the determination in step S8 is “NO”, that is, if the operation angles of the pair of wiper blades 1d and 1p have not reached the upper reversal positions PUd and PUp, the CPU 63 ends the processing. On the other hand, if the determination in step S8 is “YES”, that is, if the operation angles of the pair of wiper blades 1d and 1p have reached the upper reversal positions PUd and PUp, the CPU 63 switches the control map that has been used for generating a drive command to the heavy rain mode operation map (step S9).

For example, in a state in which the wiping device A is operating in the normal mode, the control map is switched from the normal mode operation map to the heavy rain mode operation map in step S9. By switching the control map from the normal mode operation map to the heavy rain mode operation map, the CPU 63 sets the control mode to the heavy rain mode (step S10).

That is, when the processing in step S10 is completed, the CPU 63 performs processing for generating the drive command based on the heavy rain mode operation map. Accordingly, the pair of wiper blades 1d and 1p wipe off rainwater in a relatively fast manner by reciprocating in a narrow wiping range at higher speed than in the normal mode, in which, in the narrow wiping range, while the upper reversal positions PUd and PUp are the same as those in the driver's seat normal wiping range Rd and the passenger seat normal wiping range Rp, the lower reversal positions are set to the lower reversal positions QLd and QLp which are higher than the lower reversal positions PLd and PLp in the driver's seat normal wiping range Rd and the passenger seat normal wiping range Rp.

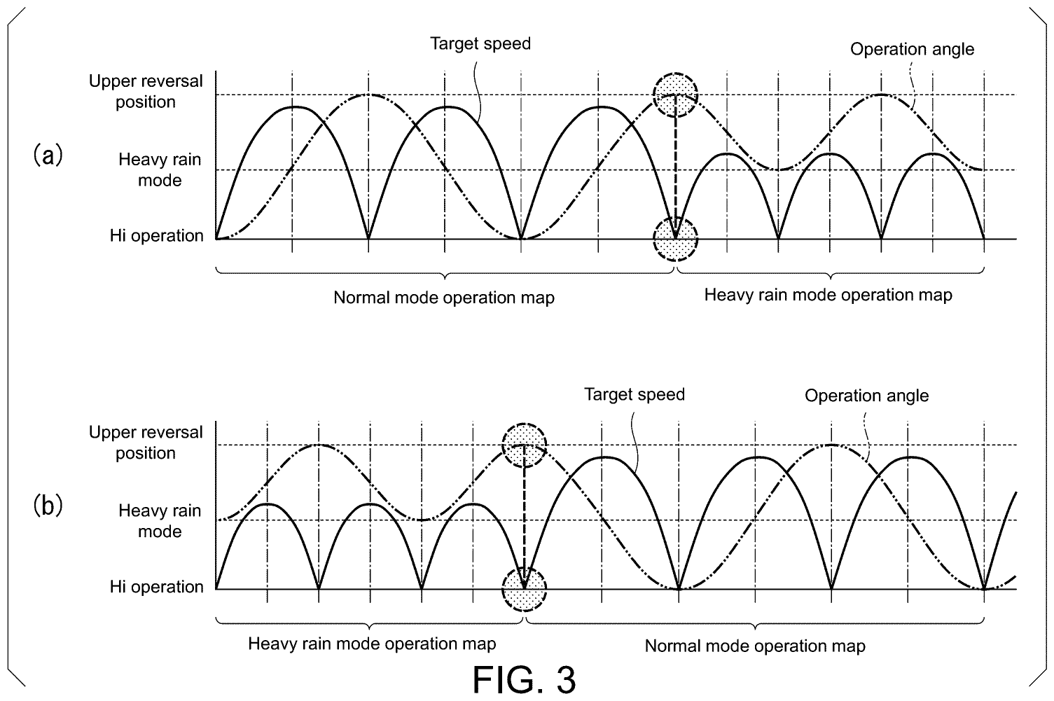

FIG. 3 is a waveform diagram showing an operation of such a wiping device A. In FIG. 3, (a) shows target speed and operation angle in a case of switching from Hi operation in the normal mode to the heavy rain mode. In FIG. 3, (b) shows target speed and operation angle in a case of switching from the heavy rain mode to Hi operation in the normal mode.

As shown in (a) and (b) of FIG. 3, in the wiping device A according to the first embodiment, a timing of switching from Hi operation in the normal mode to the heavy rain mode is set to a timing at which the operation angles of the pair of wiper blades 1d and 1p reach the upper reversal positions PUd and PUp. In the wiping device A, a timing of switching from the heavy rain mode to Hi operation in the normal mode is set to a timing at which the operation angles of the pair of wiper blades 1d and 1p reach the upper reversal positions PUd and PUp.

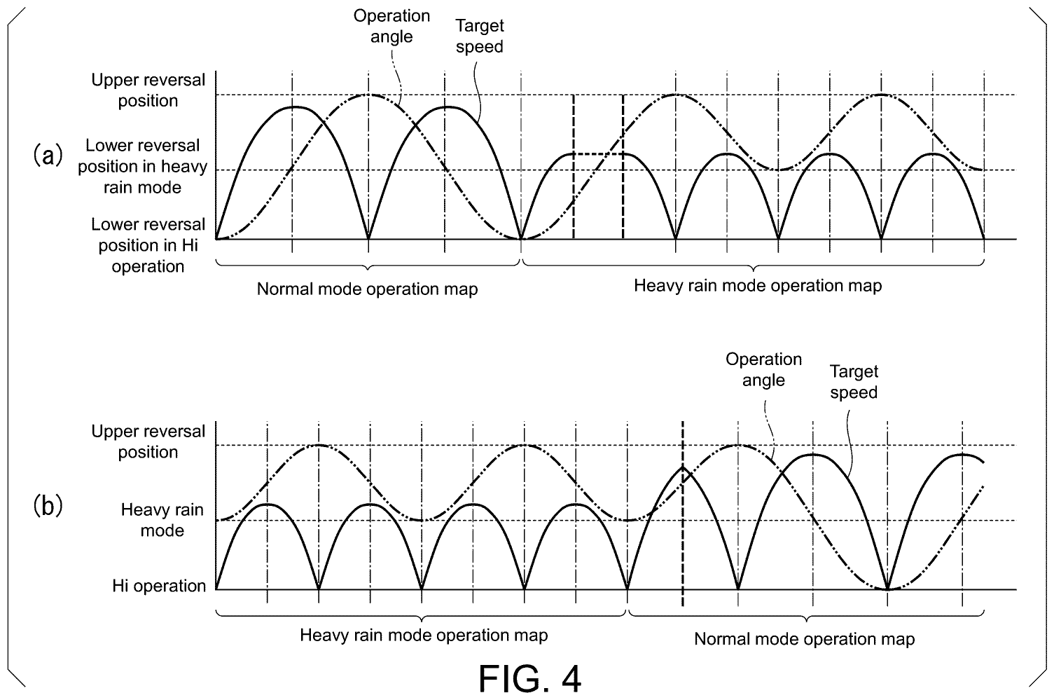

FIG. 4 is a reference diagram regarding an operation of the wiping device A according to the first embodiment according to the first embodiment. In FIG. 4, (a) shows target speed and operation angle in the case of switching from Hi operation in the normal mode to the heavy rain mode. In FIG. 4, (b) shows target speed and operation angle in the case of switching from the heavy rain mode to Hi operation in the normal mode.

As shown in (a) and (b) of FIG. 4, in this reference example, the timing of switching from Hi operation in the normal mode to the heavy rain mode is not set to the timing at which the operation angles of the pair of wiper blades 1d and 1p reach the upper reversal positions PUd and PUp. In this reference example, the timing of switching from the heavy rain mode to Hi operation in the normal mode is not set to the timing at which the operation angles of the pair of wiper blades 1d and 1p reach the upper reversal positions PUd and PUp.

Here, in the present embodiment, in the wiping range in the heavy rain mode, the upper reversal positions PUd and PUp are the same as the upper reversal positions PUd and PUp in Hi operation in the normal mode, and the lower reversal positions QLd and QLp are set to positions higher than the lower reversal positions PLd and PLp in Hi operation in the normal mode. That is, the heavy rain mode and the normal mode are the same in upper reversal position but differ in lower reversal position.

In such a relationship between the heavy rain mode and the normal mode, the upper reversal positions PUd and PUp of the pair of wiper blades 1d and 1p are a timing at which the target speed of the pair of wiper blades 1d and 1p becomes zero both before and after switching. That is, in the wiping device A according to the first embodiment, the wiping range is switched at the timing at which the target speed of the pair of wiper blades 1d and 1p becomes zero both before and after switching.

Such a wiping device A is a device that wipes off rainwater on the wiped surface W by reciprocating the pair of wiper blades 1d and 1p using the motor 4 (power source). The wiping device A includes: the drive circuit 7, driving the motor 4 (power source), and the control part 6, controlling the drive circuit 7. The control part 6 switches a wiping range at a timing at which a target speed becomes zero both before and after the switching.

According to the first embodiment like this, since the control map (operation mode), that is, the wiping range, is switched at the timing at which the target speed becomes zero both before and after the switching, it is possible to provide the wiping device A in which abnormal behavior of the pair of wiper blades 1d and 1p during switching of the control map (operation mode), that is, during switching of the wiping range, can be suppressed.

According to the first embodiment, the wiping range of the pair of wiper blades 1d and 1p is set to the normal wiping range in the normal mode and the wiping range in the heavy rain mode that is smaller than the normal wiping range. Thus, abnormal behavior of the pair of wiper blades 1d and 1p during switching between the normal mode and the heavy rain mode can be suppressed.

According to the first embodiment, the control part 6 switches between the normal mode and the heavy rain mode at the upper reversal positions PUd and PUp where the target speed becomes zero both before and after the switching. Thus, abnormal behavior of the pair of wiper blades 1d and 1p during switching between the normal mode and the heavy rain mode can be effectively suppressed.

According to the first embodiment, the motor 4 (power source) reciprocates the pair of wiper blades 1d and 1p at the same time. Thus, in the wiping device A of a single motor drive system, abnormal behavior of the pair of wiper blades 1d and 1p can be suppressed.

### Second Embodiment

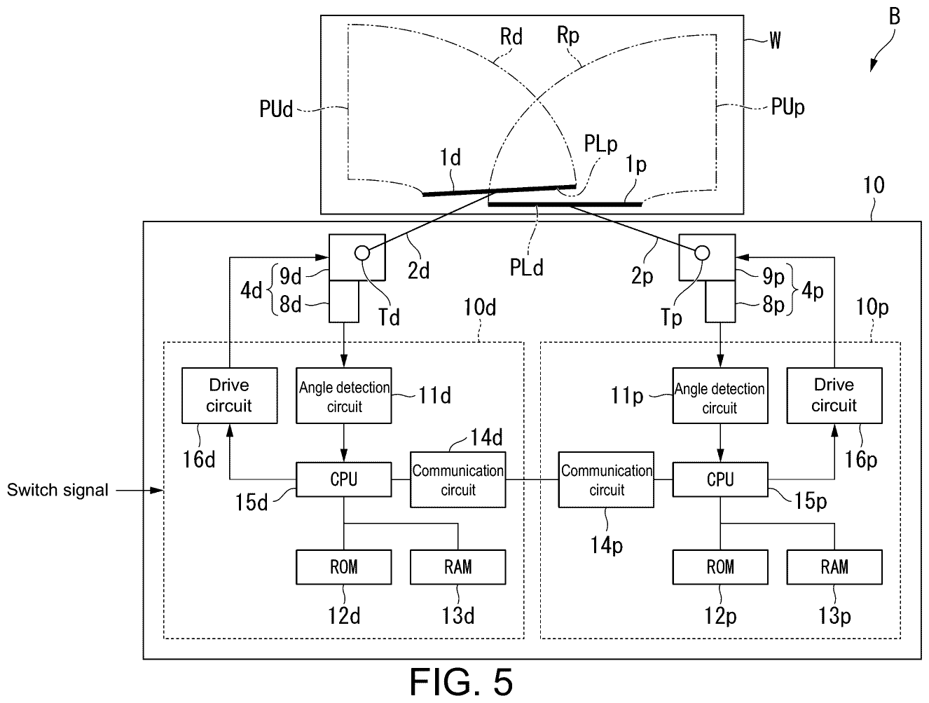

A second embodiment of the disclosure is described with reference to FIG. 5. Like the wiping device A according to the first embodiment, a wiping device B according to the second embodiment is installed in various vehicles and wipes off rainwater adhering to a surface (wiped surface W) of a windshield or a rear glass. In FIG. 5, the same reference numerals are attached to the same components as in the first embodiment.

As shown in FIG. 5, the wiping device B includes a drive control device 10. As illustrated, the drive control device 10 includes a pair of motors 4d and 4p and a pair of wiper drive control parts 10d and 10p. That is, the wiping device B is a wiping device of a dual motor drive system. The wiping device B employs an opposite wiping type in which the pair of wiper blades 1d and 1p move facing each other, as shown in FIG. 5.

The motor 4d on the driver's seat side includes a motor body 8d and a deceleration mechanism 9d. The motor 4p on the passenger seat side includes a motor body 8p and a deceleration mechanism 9p. The pair of wiper drive control parts 10d and 10p drive and control the pair of motors 4d and 4p which are power sources.

Of the pair of wiper drive control parts 10d and 10p, the wiper drive control part 10d is a drive control part corresponding to the motor 4d on the driver's seat side. The wiper drive control part 10d includes an angle detection circuit 11d, a read only memory (ROM) 12d, a random access memory (RAM) 13d, a communication circuit 14d, a central processing unit (CPU) 15d, and a drive circuit 16d.

Of the pair of wiper drive control parts 10d and 10p, the wiper drive control part 10p is a drive control part corresponding to the motor 4p on the passenger seat side. The wiper drive control part 10p includes an angle detection circuit 11p, a read only memory (ROM) 12p, a random access memory (RAM) 13p, a communication circuit 14p, a central processing unit (CPU) 15p, and a drive circuit 16p.

The motor 4d on the driver's seat side is driven and controlled by the wiper drive control part 10d, thereby causing the wiper blade 1d on the driver's seat side to perform a reciprocating motion (swinging motion) with the wiper shaft Td as a fulcrum. The motor 4p on the passenger seat side is driven and controlled by the wiper drive control part 10p, thereby causing the wiper blade 1p on the passenger seat side to perform a reciprocating motion (swinging motion) with the wiper shaft Tp as a fulcrum.

In the wiper drive control part 10d, the angle detection circuit 11d has a function similar to the angle detection circuit 5 of the first embodiment, and outputs an angle signal proportional to a rotation angle of the motor body 8d to the CPU 15d. This angle signal is a signal indicating an operation angle of the wiper blade 1d on the driver's seat side, and includes the relative position signal and the absolute position signal described in the first embodiment.

The ROM 12d is a nonvolatile memory. The ROM 12d stores a control program for the CPU 15d to perform feedback control on the wiper blade 1d on the driver's seat side. The ROM 12d stores the normal mode operation map and the heavy rain mode operation map necessary for the CPU 15d to execute the control program. The normal mode operation map and the heavy rain mode operation map indicate a target speed of the wiper blade 1d on the driver's seat side.

The RAM 13d is a volatile memory. The RAM 13d temporarily stores various data generated when the CPU 15d executes the control program. The RAM 13d temporarily stores, for example, the flag (control flag F) indicating whether the control mode being executed is the normal mode or the heavy rain mode, and the counter value (wiping count value N) indicating the wiping count in the control mode being executed.

The communication circuit 14d transmits and receives control information to and from the wiper drive control part 10p. The communication circuit 14d receives, for example, a current position of the wiper blade 1p on the passenger seat side as the control information, from the communication circuit 14p of the wiper drive control part 10p. The communication circuit 14d transmits, for example, a current position of the wiper blade 1d on the driver's seat side as the control information, to the communication circuit 14p of the wiper drive control part 10p.

The CPU 15d generates a drive command by executing the control program stored in advance in the ROM 12d, and outputs this drive command to the drive circuit 16d. When executing the control program, the CPU 15d refers to the switch signal input from the host control device, the angle signal input from the angle detection circuit 11d, the control information input from the communication circuit 14d, and the normal mode operation map and the heavy rain mode operation map stored in advance in the ROM 12d.

That is, by referring to the switch signal, the angle signal, the control information, the normal mode operation map and the heavy rain mode operation map based on the control program, the CPU 15d generates the drive command. This drive command instructs the drive circuit 16d to drive the wiper blade 1d on the driver's seat side according to the control mode (normal mode or heavy rain mode), and is a control command considering a drive control state of the wiper drive control part 10p for the wiper blade 1p on the passenger seat side.

That is, this drive command causes a movement speed of the wiper blade 1d on the driver's seat side obtained from the angle signal to become equal to the target speed indicated by the normal mode operation map or the heavy rain mode operation map, and controls the wiper blade 1d on the driver's seat side to be in synchronization with the movement of the wiper blade 1p on the passenger seat side.

The drive circuit 16d generates a drive signal based on the drive command input from the CPU 15d, and outputs the drive signal to the motor 4d. The drive circuit 16d is, for example, an inverter circuit including a plurality of switching transistors. In this case, the drive command is a pulse width modulation (PWM) signal whose duty ratio is variably set according to a deviation between the target speed and the movement speed of the wiper blade 1d on the driver's seat side.

On the other hand, in the wiper drive control part 10p, the angle detection circuit 11p has a function similar to the angle detection circuit 5 of the first embodiment, and outputs an angle signal proportional to a rotation angle of the motor body 8p to the CPU 15p. This angle signal is a signal indicating an operation angle of the wiper blade 1p on the passenger seat side, and includes the relative position signal and the absolute position signal described in the first embodiment.

The ROM 12p is a nonvolatile memory. The ROM 12p stores a control program for the CPU 15p to perform feedback control on the wiper blade 1p on the passenger seat side. The ROM 12p stores the normal mode operation map and the heavy rain mode operation map necessary for the CPU 15p to execute the control program.

The normal mode operation map and the heavy rain mode operation map indicate a target speed of the wiper blade 1p on the passenger seat side. The control program stored in the ROM 12p is substantially similar to the control program stored in the ROM 12d of the wiper drive control part 10d.

The RAM 13p is a volatile memory. The RAM 13p temporarily stores various data generated when the CPU 15p executes the control program. The RAM 13p temporarily stores, for example, the flag (control flag F) indicating whether the control mode being executed is the normal mode or the heavy rain mode, and the counter value (wiping count value N) indicating the wiping count in the control mode being executed.

The communication circuit 14p transmits and receives control information to and from the wiper drive control part 10d. The communication circuit 14p receives, for example, the current position of the wiper blade 1d on the driver's seat side as the control information, from the communication circuit 14d of the wiper drive control part 10d. The communication circuit 14p transmits, for example, the current position of the wiper blade 1p on the passenger seat side as the control information, to the communication circuit 14d of the wiper drive control part 10d.

The CPU 15p generates a drive command by executing the control program stored in advance in the ROM 12p, and outputs this drive command to the drive circuit 16p. When executing the control program, the CPU 15p refers to the switch signal input from the host control device, the angle signal input from the angle detection circuit 11p, the control information input from the communication circuit 14p, and the normal mode operation map and the heavy rain mode operation map stored in advance in the ROM 12p.

That is, by referring to the switch signal, the angle signal, the control information, the normal mode operation map and the heavy rain mode operation map based on the control program, the CPU 15p generates the drive command. This drive command instructs the drive circuit 16p to drive the wiper blade 1p on the passenger seat side according to the control mode (normal mode or heavy rain mode), and is a control command considering a drive control state of the wiper drive control part 10d for the wiper blade 1d on the driver's seat side.

That is, this drive command causes a movement speed of the wiper blade 1p on the passenger seat side obtained from the angle signal to become equal to the target speed indicated by the normal mode operation map or the heavy rain mode operation map, and controls the wiper blade 1p on the passenger seat side to be in synchronization with the movement of the wiper blade 1d on the driver's seat side.

The drive circuit 16p generates a drive signal based on the drive command input from the CPU 15p, and outputs the drive signal to the motor 4p. The drive circuit 16p is, for example, an inverter circuit including a plurality of switching transistors. In this case, the drive command is a pulse width modulation (PWM) signal whose duty ratio is variably set according to a deviation between the target speed and the movement speed of the wiper blade 1p on the passenger seat side.

Next, a characteristic operation of the wiping device B according to the second embodiment is described.

In the wiping device B, the wiper drive control part 10d controls rotation of the motor 4d on the driver's seat side based on the control program, and thereby, the wiper blade 1d on the driver's seat side performs a wiping operation on the wiped surface W. In the wiping device B, the wiper drive control part 10p controls rotation of the motor 4p on the passenger seat side based on the control program, and thereby, the wiper blade 1p on the passenger seat side performs a wiping operation on the wiped surface W.

In the wiping device B, the wiper drive control part 10d and the wiper drive control part 10p provide the control information to each other via a pair of communication circuits 14d and 14p. Thereby, the wiper blade 1d on the driver's seat side and the wiper blade 1p on the passenger seat side perform the wiping operation in synchronization.

The control of the wiper blade 1d on the driver's seat side by the wiper drive control part 10d and the control of the wiper blade 1p on the passenger seat side by the wiper drive control part 10p are similar. The processing performed by the pair of wiper drive control parts 10d and 10p when switching between the wiping range in the heavy rain mode and the wiping range in the normal mode is similar to that of the flowchart of FIG. 2 in the first embodiment.

That is, by referring to the switch signal input from the host control device, a pair of CPUs 15d and 15p in the pair of wiper drive control parts 10d and 10p recognize an operation mode indicated by an instruction from the host control device (step S1). Then, the pair of CPUs 15d and 15p execute each processing in the following steps S2 to S10 based on the recognition in step S1.

That is, the pair of CPUs 15d and 15p determine whether the heavy rain mode has been indicated by the instruction from the host control device (step S2). If the determination in step S2 is “NO”, that is, if the normal mode is indicated by the instruction from the host control device, the pair of CPUs 15d and 15p refer to the wiping count value N, thereby determining whether the wiping in the normal mode is the first wiping (first wiping) (step S3).

If the determination in step S3 is “NO”, that is, if the wiping in the normal mode is not first wiping, the pair of CPUs 15d and 15p end the processing. On the other hand, if the determination in step S3 is “YES”, that is, if the wiping in the normal mode is first wiping, the pair of CPUs 15d and 15p refer to an angle signal, thereby determining whether operation angles of the pair of wiper blades 1d and 1p have reached the upper reversal positions PUd and PUp (step S4).

If the determination in step S4 is “NO”, that is, if the operation angles of the pair of wiper blades 1d and 1p have not reached the upper reversal positions PUd and PUp, the pair of CPUs 15d and 15p end the processing. On the other hand, if the determination in step S4 is “YES”, that is, if the operation angles of the pair of wiper blades 1d and 1p have reached the upper reversal positions PUd and PUp, the pair of CPUs 15d and 15p switch the control map that has been used for generating the drive command to the normal mode operation map (step S5).

For example, in a state in which the wiping device B is operating in the heavy rain mode, the control map is switched from the heavy rain mode operation map to the normal mode operation map in step S5. By switching the control map from the heavy rain mode operation map to the normal mode operation map, the pair of CPUs 15d and 15p set the control mode to the normal mode (step S6).

That is, when the processing in step S6 is completed, the pair of CPUs 15d and 15p perform processing for generating the drive command based on the normal mode operation map. Accordingly, the pair of wiper blades 1d and 1p wipe off rainwater in a normal manner by reciprocating in the driver's seat normal wiping range Rd and the passenger seat normal wiping range Rp extending from the lower reversal positions PLd and PLp to the upper reversal positions PUd and PUp.

If the determination in step S2 is “YES”, that is, if the heavy rain mode is indicated by the instruction from the host control device, the pair of CPUs 15d and 15p refer to the wiping count value N, thereby determining whether the wiping in the heavy rain mode is the first wiping (first wiping) (step S7).

If the determination in step S7 is “NO”, that is, if the wiping in the heavy rain mode is not first wiping, the pair of CPUs 15d and 15p end the processing. On the other hand, if the determination in step S7 is “YES”, that is, if the wiping in the heavy rain mode is first wiping, the pair of CPUs 15d and 15p refer to an angle signal, thereby determining whether the operation angles of the pair of wiper blades 1d and 1p have reached the upper reversal positions PUd and PUp (step S8).

If the determination in step S8 is “NO”, that is, if the operation angles of the pair of wiper blades 1d and 1p have not reached the upper reversal positions PUd and PUp, the pair of CPUs 15d and 15p end the processing. On the other hand, if the determination in step S8 is “YES”, that is, if the operation angles of the pair of wiper blades 1d and 1p have reached the upper reversal positions PUd and PUp, the pair of CPUs 15d and 15p switch the control map that has been used for generating a drive command to the heavy rain mode operation map (step S9).

For example, in a state in which the wiping device B is operating in the normal mode, the control map is switched from the normal mode operation map to the heavy rain mode operation map in step S9. By switching the control map from the normal mode operation map to the heavy rain mode operation map, the pair of CPUs 15d and 15p set the control mode to the heavy rain mode (step S10).

That is, when the processing in step S10 is completed, the pair of CPUs 15d and 15p perform processing for generating the drive command based on the heavy rain mode operation map. Accordingly, the pair of wiper blades 1d and 1p wipe off rainwater in a relatively fast manner by reciprocating in a narrow wiping range at higher speed than in the normal mode, in which, in the narrow wiping range, while the upper reversal positions PUd and PUp are the same as those in the driver's seat normal wiping range Rd and the passenger seat normal wiping range Rp, the lower reversal positions are set to the lower reversal positions QLd and QLp which are higher than the lower reversal positions PLd and PLp in the driver's seat normal wiping range Rd and the passenger seat normal wiping range Rp.

Such a wiping device B is a device that wipes off rainwater on the wiped surface W by reciprocating the pair of wiper blades 1d and 1p using the pair of motors 4d and 4p (power sources). The wiping device B includes: the pair of drive circuits 16d and 16p, driving the pair of motors 4d and 4p (power sources); and the pair of wiper drive control parts 10d and 10p (control parts), respectively controlling the pair of drive circuits 16d and 16p. The pair of wiper drive control parts 10d and 10p (control parts) switch a wiping range at a timing at which a target speed becomes zero both before and after the switching.

According to the second embodiment like this, since the control map (operation mode), that is, the wiping range, is switched at the timing at which the target speed becomes zero both before and after the switching, it is possible to provide the wiping device B in which abnormal behavior of the pair of wiper blades 1d and 1p during switching of the control map (operation mode), that is, during switching of the wiping range, can be suppressed.

According to the second embodiment, the wiping range of the pair of wiper blades 1d and 1p is set to the normal wiping range in the normal mode and the wiping range in the heavy rain mode that is smaller than the normal wiping range. Thus, abnormal behavior of the pair of wiper blades 1d and 1p during switching between the normal mode and the heavy rain mode can be suppressed.

According to the second embodiment, the pair of wiper drive control parts 10d and 10p switch between the normal mode and the heavy rain mode at the upper reversal positions PUd and PUp where the target speed becomes zero both before and after the switching. Thus, abnormal behavior of the pair of wiper blades 1d and 1p during switching between the normal mode and the heavy rain mode can be effectively suppressed.

Furthermore, in the second embodiment, the pair of motors 4d and 4p (power sources) are provided. Of the pair of wiper blades 1d and 1p, the motor 4d on the driver's seat side causes the wiper blade 1d similarly on the driver's seat side to reciprocate, and the motor 4p on the passenger seat side causes the wiper blade 1p similarly on the passenger seat side to reciprocate.

That is, in the second embodiment, in the wiping device B of a dual motor drive system in which the pair of motors 4d and 4p (power sources) reciprocate their corresponding wiper blade, it is possible to suppress abnormal behavior of the pair of wiper blades 1d and 1p.

In the second embodiment, while the wiper blade 1d on the driver's seat side is wiping in a narrow wiping range on the driver's seat side in the heavy rain mode, by the pair of wiper drive control parts 10d and 10p, the wiper blade 1p on the passenger seat side, for example, can be stopped (made to stand by) at the lower reversal position PLp on the passenger seat side so as not to interfere with the wiper blade 1d on the driver's seat side. In addition, in the second embodiment, the wiper blade 1p on the passenger seat side can also be stopped (made to stand by) at the upper reversal position PUp on the passenger seat side, and the wiper blade 1p on the passenger seat side is also able to wipe in a narrow wiping range on the passenger seat side.

In the first and second embodiments, each of the upper reversal positions PUd and PUp in the wiping ranges Rd and Rp in the normal mode and the narrow wiping range in the heavy rain mode is the same position where reversal occurs even if switching to each mode is performed. However, it is also possible to switch from the upper reversal positions PUd and PUp in the normal mode to the upper reversal position in the heavy rain mode each time switching to each mode is performed.

In this case, wiping can be performed in a narrow wiping range between each upper reversal position and each lower reversal position in the heavy rain mode. As shown in FIG. 3, it is possible to switch control to wipe in the narrow wiping range at each upper reversal position.

Furthermore, the wiping devices A and B according to each of the above embodiments are devices that wipe off rainwater on the wiped surface W by reciprocating a pair of wiper blades 1d and 1p using each motor 4, 4d, and 4p (power source). It is conceivable to use a brushless motor as each motor 4, 4d, and 4p (power source).

As is well known, a brushless motor is a motor (power source) excellent in speed controllability. By adopting a brushless motor as a drive source for the pair of wiper blades 1d and 1p, when each motor 4, 4d, and 4p (brushless wiper motor) repeats forward and reverse rotations at high speed in an operation in the heavy rain mode, since wear debris of a brush due to sliding between the brush and a commutator, as in a brushed motor, is not formed, it is possible to extend the life of each motor 4, 4d, and 4p.

By adopting a brushless wiper motor for each motor 4, 4d, and 4p, it is possible to repeat forward and reverse rotations smoothly, thereby enabling accurate reversal at the upper and lower reversal positions set for the heavy rain mode.

1. A wiping device that wipes off rainwater on a wiped surface by reciprocating a wiper blade using a predetermined power source, the wiping device comprising:
a drive circuit, driving the power source; and
a control part, controlling the drive circuit, wherein
the control part switches a wiping range at a timing at which a target speed becomes zero both before and after the switching.

2. The wiping device according to claim 1, wherein
the wiping range comprises: a normal wiping range in a normal mode; and a narrow wiping range in a heavy rain mode, smaller than the normal wiping range.

3. The wiping device according to claim 2, wherein
the control part performs the switching from the normal mode to the heavy rain mode at an upper reversal position of the wiper blade.

4. The wiping device according to claim 1, wherein
the power source reciprocates a pair of the wiper blades at the same time.

5. The wiping device according to claim 2, wherein
the power source reciprocates a pair of the wiper blades at the same time.

6. The wiping device according to claim 1, wherein
the power source is provided in a pair, and the power source provided in a pair reciprocates the wiper blade corresponding thereto.

7. The wiping device according to claim 2, wherein
the power source is provided in a pair, and the power source provided in a pair reciprocates the wiper blade corresponding thereto.
